(19) United States
(12) Patent Application Publication
(10) Pub. No.: US 2023/0413412 A1
(43) Pub. Date: Dec. 21, 2023

(54) CONSUMABLES FOR PLASMA CUTTING TORCH

(71) Applicant: The ESAB Group, Inc., North Bethesda, MD (US)

(72) Inventor: Geoffrey Hamilton Putnam, Charlestown, NH (US)

(21) Appl. No.: 18/459,574

(22) Filed: Sep. 1, 2023

Related U.S. Application Data
(63) Continuation of application No. PCT/US2023/015629, filed on Mar. 20, 2023.
(60) Provisional application No. 63/322,481, filed on Mar. 22, 2022.

(51) Int. Cl. H05H 1/28; B23K 10/00; B23K 37/00; H05H 1/34

(52) U.S. Cl. CPC H05H 1/28; B23K 10/00; B23K 37/003; H05H 1/3473

(57) ABSTRACT

The present invention relates to techniques for absorbing and dissipating heat from a cutting torch during a plasma cutting process/operation, including a piercing stage. In accordance with at least one embodiment of the present invention, an outer shield club with a deflector ring absorbs and dissipates heat from a cutting torch including consumable components disposed therein. The shield club surrounds and protects the outermost consumable (e.g., nozzle/tip, shield, etc.) and dissipates heat from the plasma cutting operation. In some implementations, a flow of cooling water flows between and cools the outermost consumable and the shield club.

### CROSS-REFERENCE TO RELATED APPLICATION

This application is a continuation of International App. No. PCT/US2023/015629, which was filed on Mar. 20, 2023, and which claims priority to U.S. Provisional Application No. 63/322,481, filed Mar. 22, 2022. The contents of each of these applications is incorporated herein by reference in entirety.

### FIELD OF INVENTION

The present invention relates to the field of plasma cutting torches, and in particular, consumables for plasma cutting torches.

### BACKGROUND

When cutting heavy materials, such as a 4-inch thick steel plate, using a plasma cutting process/operation, a torch is exposed to a high heat environment for an extended period of time. The exposure to the high heat can cause damage to the plasma torch and its parts (e.g., a consumable stack including a cartridge, an electrode, nozzle or tip, shield cup, etc.), resulting in premature failure and poor cut quality. When premature failure occurs, the torch may need costly repairs and/or replacement of consumables (e.g., if the consumables are destroyed or damaged), both of which require a shutdown of a plasma cutting operation. Consequently, it may be difficult to cut heavy materials with high levels of efficiency and/or productivity and, moreover, cutting heavy materials may drastically shorten the lifespan of consumables. Further, poor cut quality may require additional processing of the workpiece (e.g., with milling).

### SUMMARY

The present invention relates to techniques for dissipating heat from a cutting torch during a plasma cutting process/operation, including a piercing stage. In accordance with at least one embodiment of the present invention, an outer shield assembly (also called a “shield club,” secondary shield, secondary shield assembly, or the like) absorbs and dissipates heat from a cutting torch including consumable components disposed therein. The outer shield surrounds and protects the outermost consumable(s) (e.g., nozzle/tip, shield, shield cup etc.) and dissipates heat from the plasma cutting operation. In some implementations, a flow of cooling water flows between and cools the outermost consumable(s) and the outer shield. In some implementations, the outer shield includes a deflector ring for deflecting spatter ejected during a plasma cutting operation and/or for increasing a surface area of a heat dissipation area of a consumable stack.

### BRIEF DESCRIPTION OF THE DRAWINGS

To complete the description and in order to provide for a better understanding of the present invention, a set of drawings is provided. The drawings form an integral part of the description and illustrate an embodiment of the present invention, which should not be interpreted as restricting the scope of the invention, but just as an example of how the invention can be carried out. The drawings comprise the following figures:

FIG. 1A is a perspective view of an automated cutting system that may utilize the consumables presented herein, according to an example embodiment of the present disclosure.

FIG. 1B is a perspective view of an automated cutting head that may be included in the automated cutting system illustrated in FIG. 1A, according to an example embodiment of the present disclosure.

FIG. 2 is a perspective view of a consumable stack according to an example embodiment of the present disclosure.

FIG. 3 is an exploded view of the consumable stack of FIG. 2.

FIG. 4 is a cross-sectional view of the consumable stack of FIG. 2.

FIG. 5 is a partial cross-sectional view of the consumable stack of FIG. 2 illustrating a flow of cooling fluid.

FIG. 6 is a side view of a consumable stack according to a second example embodiment of the present disclosure.

FIG. 7 is a cross sectional view of the consumable stack of FIG. 6 illustrating a flow of cooling fluid.

Like reference numerals have been used to identify like elements throughout this disclosure.

### DETAILED DESCRIPTION

The following description is not to be taken in a limiting sense but is given solely for the purpose of describing the broad principles of the invention. Embodiments of the invention will be described by way of example, with reference to the above-mentioned drawings showing elements and results according to the present invention.

Generally, the techniques for dissipating heat from a cutting torch include an outer shield assembly (sometimes referred to herein as a “shield club,” “shield club assembly,” “secondary shield,” “outer shield assembly,” “secondary shield assembly,” etc.) surrounding a consumable stack of a cutting torch. The outer shield club assembly protects the consumable stack by absorbing and dissipating heat from a plasma cutting process/operation. In particular, the cutting operation may be a high-amp operation (e.g., about 400 Amps or more, such as approximately 800 Amps or more) for piercing and cutting thick materials, such as a 4-inch thick stainless steel plate. For simplicity, the consumables of a consumable stack disposed interiorly of the outer shield are referred to herein as “consumable stack 20.” However, such terminology in no way implies that the outer shield is not a consumable component and/or is not part of a consumable stack. Instead, such terminology is only used for clarity and simplicity in the present application.

In some implementations, a cooling fluid (e.g., water) may flow between the outer shield club assembly and an outermost consumable(s) of the consumable stack. The heat absorbed by the shield club assembly may be received and removed by the cooling fluid. The shield club assembly may receive the flow of cooling fluid from the consumable stack, and/or from a separate inlet channel extending radially through the outer shield club assembly. The flow of cooling fluid may exit the outer shield club assembly through the consumable stack, through an outlet channel extending radially through the outer shield club assembly, and/or through an orifice disposed at a distal end of the shield club assembly. In some implementations, the shield club assembly may further include a deflector ring for deflecting spatter from the cutting operation. The deflector ring may receive and remove (i.e., dissipate) heat from any portion of the consumable stack (or the shield club assembly alone), either in combination with water cooling or independent of water cooling. Generally, the deflector ring increases a surface area of a heat dissipation area of a consumable stack and/or outer shield club assembly and thus, improves cooling for the consumable stack and/or outer shield assembly.

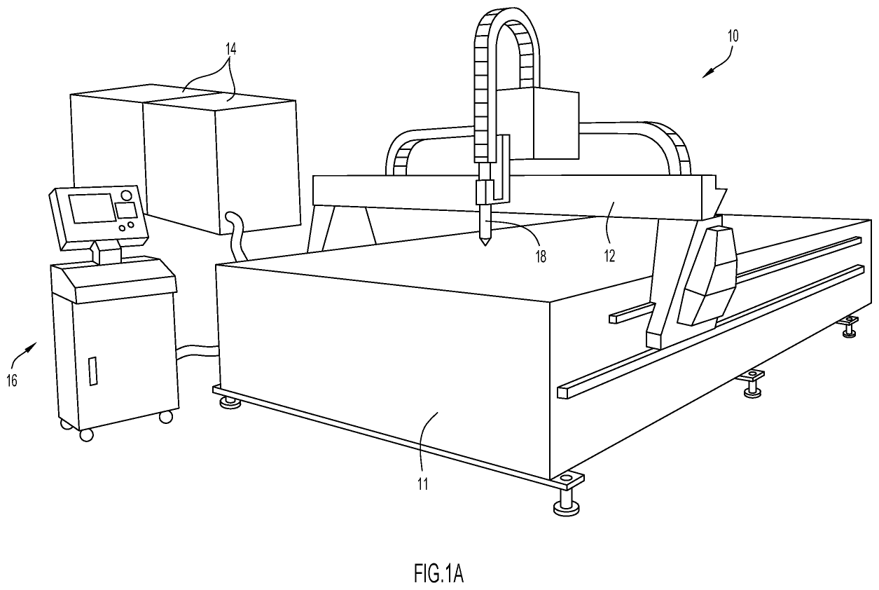

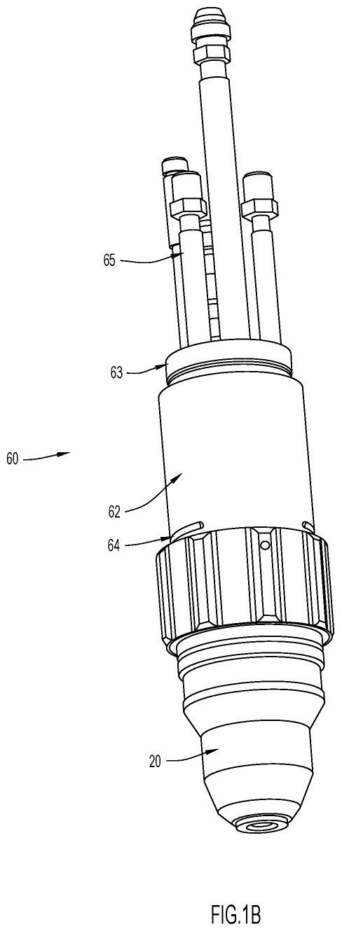

FIG. 1A illustrates an example embodiment of an automated cutting system 10 that may execute the techniques presented herein. That is, FIG. 1A illustrates an example embodiment of an automated cutting system 10 that may utilize the consumables presented herein. However, this automated cutting system 10 is merely presented by way of example and the techniques presented herein may also be executed by manual cutting systems and/or automated cutting systems that differ from the automated cutting system 10 of FIG. 1A (e.g., any robotic or partially robotic cutting system). That is, any desired plasma cutting system may utilize the consumable presented herein and the cutting system 10 illustrated in FIG. 1A is provided for illustrative purposes.

At a high-level, the cutting system 10 includes a table 11 configured to receive a workpiece (not shown), such as, but not limited to, sheets of metal. The automated cutting system also includes a positioning system 12 that is mounted to the table 11 and configured to translate or move along the table 11. At least one automated plasma arc torch 18 is mounted to the positioning system 12 and, in some embodiments, multiple automated plasma arc torches 18 may be mounted to the positioning system 12. The positioning system 12 may be configured to move, translate, and/or rotate the torch 18 in any direction (e.g., to provide movement in all degrees of freedom).

Additionally, at least one power supply 14 is operatively connected to the automated plasma arc torch 18 and configured to supply (or at least control the supply of) electrical power and flows of one or more fluids to the automated plasma arc torch 18 for operation. Finally, a controller or control panel 16 is operatively coupled to and in communication with the automated plasma arc torch 18, the one or more power supplies 14, and the positioning system 12. The controller 16 may be configured to control the operations of the automated plasma arc torch 18, one or more power supplies 14, and/or the positioning system 12, either alone or in combination with the one or more power supplies 14.

In at least some embodiments, the one or more power supplies 14 meter one or more flows of fluid received from one or more fluid supplies before or as the one or more power supplies 14 supply gas to the torch 18 via one or more cable conduits. Additionally or alternatively, the automated cutting system 10 may include a separate fluid supply unit (not shown) or units that can provide one or more fluids to the automated torch 18 independent of the one or more power supplies 14. To be clear, as used herein, the term “fluid” shall be construed to include a gas or a liquid. The one or more power supplies 14 may also condition, meter, and supply power to the automated torch 18 via one or more cables, which may be integrated with, bundled with, or provided separately from cable conduits for fluid flows. Additional cables for data, signals, and the like may also interconnect the controller 16, the automated plasma arc torch 18, the power supply 14, and/or the positioning system 12. Any cable or cable conduit/hose included in the automated cutting system 10 may be any length. Moreover, each end of any cable or cable conduit/hose may be connected to components of the automated cutting system 10 via any connectors now known or developed hereafter (e.g., via releasable connectors).

FIG. 1B illustrates an example embodiment of an automated cutting head 60 that may be used with an automated cutting system executing the techniques presented herein (e.g., the cutting system 10 of FIG. 1A). As can be seen, the cutting head 60 includes a body 62 that extends from a first end 63 (e.g., a connection end 63) to a second end 64 (e.g., an operating or operative end 64). The connection end 63 of the body 62 may be coupled (in any manner now known or developed hereafter) to an automation support structure (e.g., a cutting table, robot, gantry, etc., such as positioning system 12). Meanwhile, conduits 65 extending from the connection end 63 of the body 62 may be coupled to like conduits in the automation support structure (e.g., positioning system 12) to connect the automated cutting head 60 to a power supply, one or more fluid supplies, a coolant supply, and/or any other components supporting automated cutting operations.

At the other end, the operative end 64 of the body 62 may receive interchangeable components, including consumable component stack 20 that facilitate cutting operations. For simplicity, FIGS. 1A and 1B do not illustrate connections portions of the body 62 that allow consumable components 20 to connect to the torch body 62 in detail. However, it should be understood that the cutting consumables 20, such as those illustrated in the Figures, may be coupled to a torch body 62 in any manner. Moreover, to be clear, the consumable stacks depicted in the Figures (with an external and cross-sectional views) are merely representative of consumable stacks that may be used with an automated torch head 60 to implement the techniques presented herein. Similarly, while none of the Figures of the present application fully illustrate an interior of torch body 62, it is to be understood that any unillustrated components that are typically included in a torch, such as components that facilitate cutting operations, may (and, in fact, should) be included in a torch executing example embodiments of the present application.

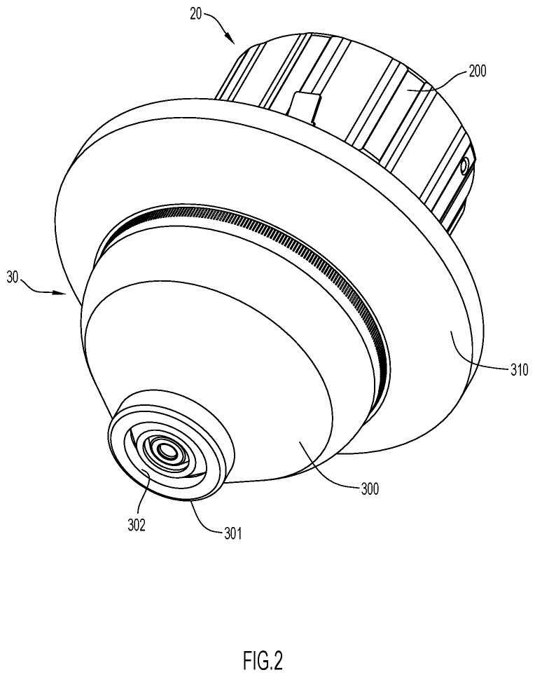

Now referring to FIGS. 2-4 for a description of an exemplary embodiment of a shield club assembly 30 for encasing and protecting the consumable stack 20 (i.e., other consumables of a consumable stack in which the shield club assembly 30 is included). The shield club assembly 30 (also called a secondary shield, outer shield assembly, secondary shield assembly, or the like) comprises a shield club 300 and a deflector ring 310. The shield club 300 includes a distal end 301 having distal opening 302 and a proximal end 303 having a proximal opening 304. The shield club 300 is configured to receive the consumable stack 20 through the proximal opening 304. That is, the shield club 300 defines an internal cavity and the consumable stack is received in the cavity through the proximal opening 304. The distal opening 302 provides an outlet from the cavity for a plasma arc and process gases to exit from the consumable stack 20.

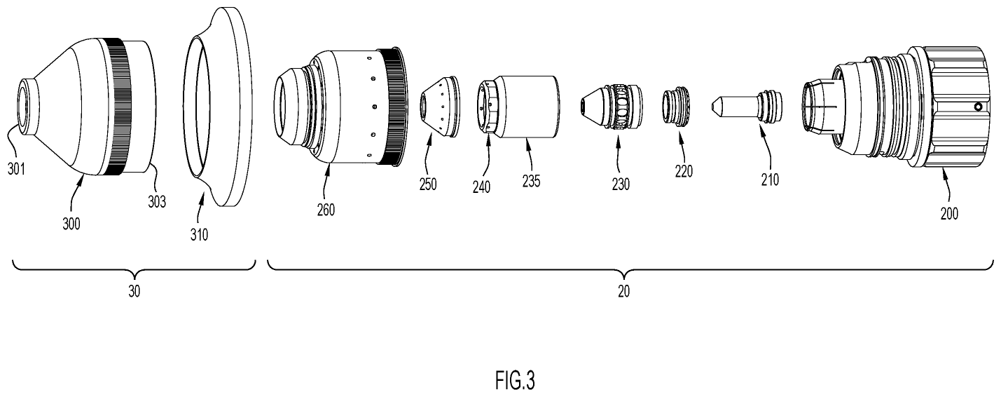

The shield club 300 is mounted to the outermost consumable(s) of the consumable stack 20. As shown in FIG. 3, in the depicted embodiment, the consumable stack 20 includes a plurality of coaxially aligned components comprising a cartridge body 200, an electrode 210, a plasma gas distributor 220, a nozzle 230, a tip retainer 235, a shield gas distributor 240, a shield or shield cap 250, and a shield cup 260. In the embodiment depicted in FIGS. 2-4, the shield club 300 is mounted to the shield cup 260. In implementations without the shield cup 260, the shield club 300 may be mounted to a shield surrounding the nozzle 230, the nozzle 230, the cartridge body 200, and/or the torch head 60. That is, in other implementations, the shield club 300 may be installed on any such consumable stack in any desirable manner. In fact, in some implementations, the shield club 300 may couple the consumable stack 20 to the torch head 60. Moreover, while the consumable stack 20 is depicted with certain components, embodiments are not limited thereto, and certain components (e.g., shield cup, shield, cartridge body, etc.) may be omitted and the function associated with those components may be provided by structures in the torch head 60. That is, in other implementations, the shield club 300 may be installed on a consumable stack formed in any desirable manner (e.g., with any combination of connections or connectors) with any combination of components now known or developed hereafter.

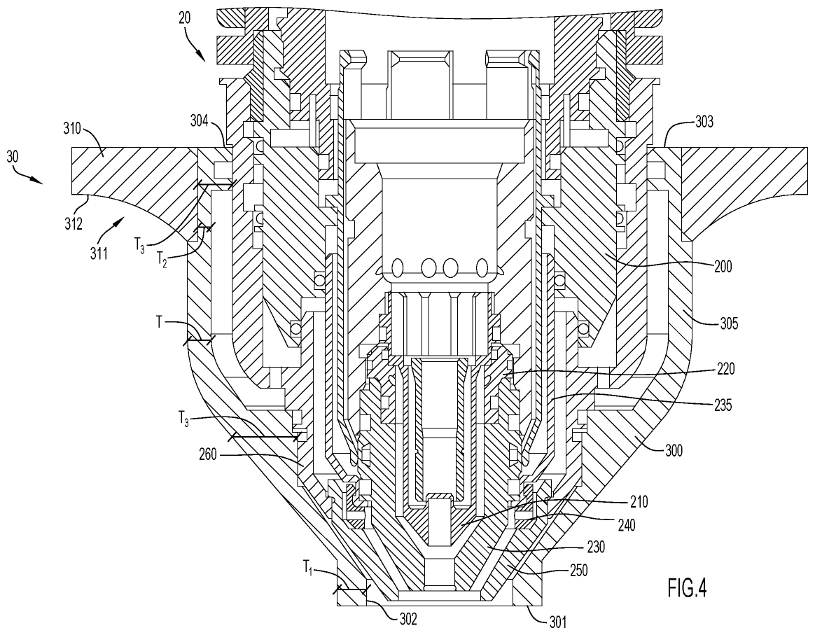

Now referring to FIG. 4, but with continued reference to FIGS. 2 and 3, the shield club 300 is sized and shaped to protect the consumable stack 20 from excess heat and spatter during an arc processing operation. To protect the consumable stack 20, the shield club 300 is defined by a sidewall 305 defining a cavity for receiving the consumable stack. The sidewall 305 has a cross-sectional, or radial, thickness T as measured perpendicularly, or radially, from a central longitudinal axis of the shield club 300. In some implementations, the thickness T of the sidewall 305 may be measured perpendicularly from an outer surface to an inner surface of the sidewall 305. Alternatively, the thickness T of the sidewall 305 may be measured perpendicularly from the inner surface to the outer surface of the sidewall 305. The shield club 300 may be made of copper, steel, iron, nickel, titanium, tungsten, and/or other metals, or any combinations (e.g., alloys) thereof suitable for absorbing and conducting heat. The thickness T is set to absorb and dissipate an amount of heat emitted from the plasma cutting operation and/or conducted thereto by spatter contacting the shield club 300. The greater the thickness T, the greater the thermal mass or heat capacity of the shield club 300 (i.e., the amount of heat the shield club 300 can absorb without melting). The thickness T is based on the type of material used in constructing the shield club 300 and the amount of heat generated by a plasma cutting process/operation. For example, during a plasma cutting operation, heat is emitted from the plasma arc and the heated workpiece and absorbed by the shield club 300. Additionally, heat may be transferred to the shield club 300 when contacting molten materials (e.g., metal, slag, dross, spatter etc.) ejected from the workpiece during the plasma cutting operation. The material and thickness T of the shield club 300 is selected to absorb and dissipate the heat received from the plasma cutting operation and/or the ejected spatter such that the consumable stack 20 is not excessively worn or damaged. The shield club 300 may also absorb and/or dissipate heat from the one or more components of the consumable stack 20. For example, consumable components in contact with and/or adjacent to the shield club 300 may conduct and/or radiate heat that may be then absorbed and dissipated by the shield club 300.

In some implementations, the radial or the cross-sectional thickness T of the sidewall 305 of the shield club 300 may vary between the distal end 301 and the proximal end 303 to improve the local and overall thermal mass or heat capacity of the shield club 300. For example, a first cross-sectional thickness T₁ may be greater at the distal end 301 than a second cross-sectional thickness T₂ near the proximal end 303. As noted above, the thickness T impacts thermal mass. That is, the greater the thermal mass, the more heat the shield club 300 may absorb. Because the distal end 301 is exposed to more heat and spatter than the proximal end 303, the first thickness T₁ (and thus thermal mass) is greater than the second thickness T₂.

Additionally, the sidewall 305 includes a third cross-sectional thickness T₃ where an interior surface of the shield club 300 engages, or otherwise contacts, one or more consumables (e.g., shield cup 260, shield 250, tip retainer 235, cartridge body 200, etc.). The third cross-sectional thickness T₃ may be greater than each of the first thickness T₁ and the second thickness T₂. The one or more consumables contacting the shield club sidewall 305 may be heated during the arc processing operation, and the shield club 300 may absorb and/or dissipate at least some of the heat from these consumable(s), in addition to absorbing heat from the arc processing operation and/or spatter. Thus, the third thickness T₃ is selected based on a desired local thermal mass of the shield club 300. That is, the local cross-sectional thickness T of a particular portion the sidewall 305 may be set based on the desired thermal mass of the particular portion of the sidewall 305 to withstand received heat, radiation, and/or spatter from the arc process operation. Consequently, the cross-sectional thickness T of the sidewall 305 may vary between the distal end 301 and the proximal end 303.

However, in some implementations, the cross-sectional thickness T of the sidewall 305 of the shield club 300 may be substantially constant/consistent and be selected or set based on an overall desired thermal mass of the shield club 300. That is, the thickness T of the sidewall 305 may not vary between the distal end 301 and the proximal end 303.

In the embodiment depicted in FIGS. 2-4, the shield club assembly 30 includes a deflector ring 310 for protecting the torch head 60 and consumable stack 20 from spatter ejected during the plasma cutting operation. The deflector ring 310 surrounds (i.e., concentric with) the shield club 300 at the proximal end 303. A distal side 311 of the deflector ring has a curved surface 312 that directs spatter ejected from the workpiece away from the shield club 300 and torch head 60. For example, spatter may be ejected from the workpiece during a piercing or cutting operation, towards the torch head 60. The spatter may contact the curved surface 312 of the deflector ring 310. The curved surface 312 may deflect the spatter radially away from the torch head 60 and shield club 300. Consequently, the deflector ring 310 reduces instances of molten spatter contacting and damaging the consumable stack 20, the shield club 300, and the torch head 60.

Additionally, generally, the deflector ring 310 expands the radial footprint of the consumable stack 20 and/or the shield club 300, which may create a larger surface area from which heat may dissipate from the consumable stack 20 and/or the shield club 300. That is, the deflector ring 310 may create a heat sink for the shield club assembly 30—with the depicted embodiment essentially providing a single, annular fin. In fact, although not shown, in some implementations, the curved surface 312 may include features to increase heat dissipation/heat transfer, such as fins, texturing, knurling, etc. Generally, at least because the deflector ring 310 is positioned at the proximal end 303 of the shield club 300, heat may tend to migrate towards the deflector ring 310 during an arc processing operation. Then, the expanded surface area of the deflector ring 310 (created by the expanded radial footprint) may provide enhanced heat dissipation from the consumable stack 20 and/or the shield club 300.

In some implementations, the shield club 300 may be omitted and the deflector ring 310 may be coupled directly to the consumable stack 20, one or more outermost components of the consumable stack 20, the cartridge body 200, and/or the torch head 60. In some implementations, the deflector ring 310 may be omitted from the shield club assembly 30. Such constructions may realize the same advantages as discussed above (e.g., spatter protection and enhanced heat dissipation).

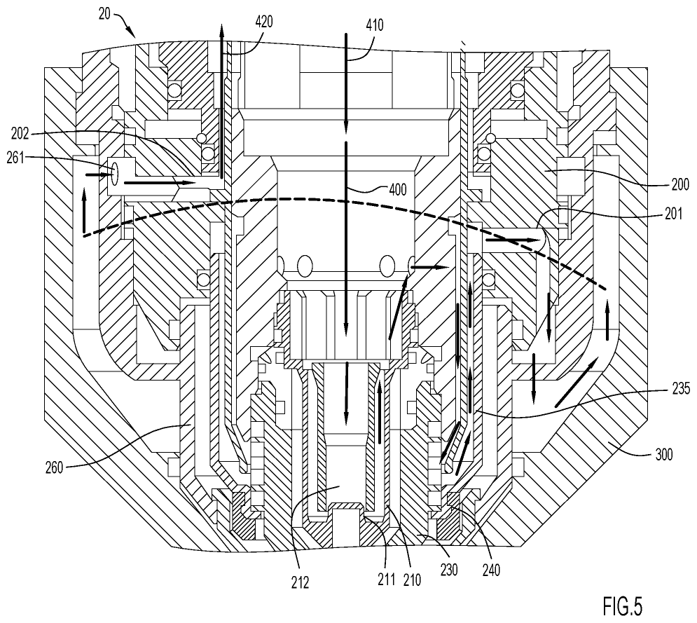

Now referring to FIG. 5, an internal flow of cooling fluid 400 for cooling the consumable stack 20 and the shield club assembly 30 is depicted. The cooling fluid 400 (e.g., water, air, etc.) enters the consumable stack 20 via an inlet port 410. The cooling fluid 400 flows through the cartridge body 200 and into the electrode 210 to an electrode distal end 211 via an electrode coolant tube 212. The cooling fluid 400 flows from the electrode distal end 211 back up the electrode 210 and radially through a portion of the cartridge body 200. The cooling fluid 400 then flows down along the cartridge body 200 to an exterior surface of the nozzle 230 (between the cartridge body 200 and an anode). The cooling fluid 400 flows away from the nozzle 230 by flowing upwards to the cartridge body 200 along a path between the anode and the tip retainer 235. Then the cooling fluid 400 flows through an outlet channel 201 in the cartridge body 200 to the shield cup 260. In the depicted embodiment, the outlet channel 201 extends radially outward and then extend axially downward through a portion of the cartridge body 200.

From the shield cup 260, the cooling fluid 400 flows into a cavity of the shield club 300. The cooling fluid 400 flows through a radial gap or channel between the shield club 300 and the shield cup 260 before entering a radially extending return port 261 of the shield cup 260. The cooling fluid 400 flows radially from the return port 261 through a return channel 202 in the cartridge body 200. The return channel 202 guides the cooling fluid 400 radially inward and then axially upwards towards a cartridge outlet port 420 where it exits the cartridge body 200. The cooling fluid 400 flows through the torch head 60 and back to a cooling fluid reservoir. The flow of the cooling fluid 400 is depicted as a single flow path. However, the depicted single flow path is representative of multiple flow paths arranged radially about the consumable stack 20. That is, the consumable stack 20 includes a plurality of channels disposed radially about the assembly to guide the cooling fluid 400 through multiple, radially offset flow paths. While a specific flow path of the cooling fluid 400 is depicted in FIG. 5, embodiments are not limited thereto. The cooling fluid 400 may flow through one or more components of the consumable stack 20 in any desired manner, path, and/or sequent to cool the consumable stack 20 and shield club 300.

Regardless of the specific flow path of the cooling fluid 400, the cooling fluid 400 cools and dissipates heat from the consumable stack 20 and shield club assembly 30. The cooling fluid 400 absorbs and carries away heat from each component that it contacts as it flows through the consumable stack 20 and shield club assembly 30. Meanwhile, a tight contact fit between the deflector ring 310 and the shield club 300 facilitates cooling the deflector ring 310. That is, the cooling fluid 400 cools the shield club 300 which in turn cools the deflector ring 310. Additionally or alternatively, the deflector ring 310 may dissipate heat to the atmosphere (i.e., dissipate heat externally, perhaps independently of cooling fluid). In any case, heat removed from the consumable stack 20 and shield club assembly 30 by the cooling fluid 400 leaves the consumable stack 20 with the cooling fluid 400 via outlet port 420. The heat is then dissipated via a heat sink disposed in or near the cooling fluid reservoir. Additionally or alternatively, in some instances, a portion of the cooling fluid 400 may flow from a radial gap between the shield club 300 and the shield cup 260 and/or the shield 250 to the distal opening 302. That is, some of the cooling fluid 400 may be discharged from the shield club 300 through the distal opening 302. the cooling fluid 400 may be discharged from the shield club 300 via the distal opening 302.

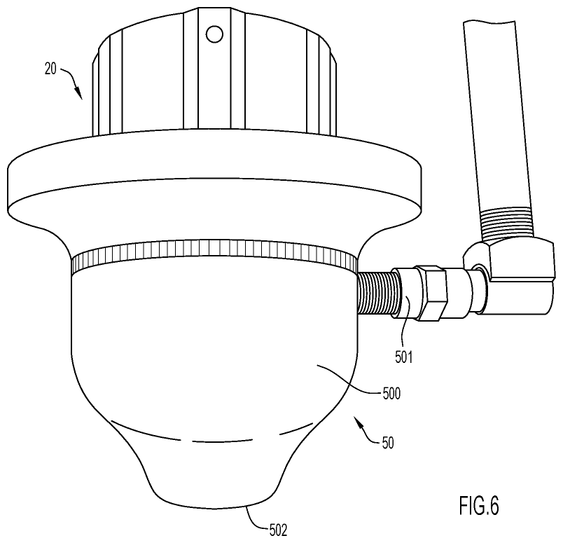

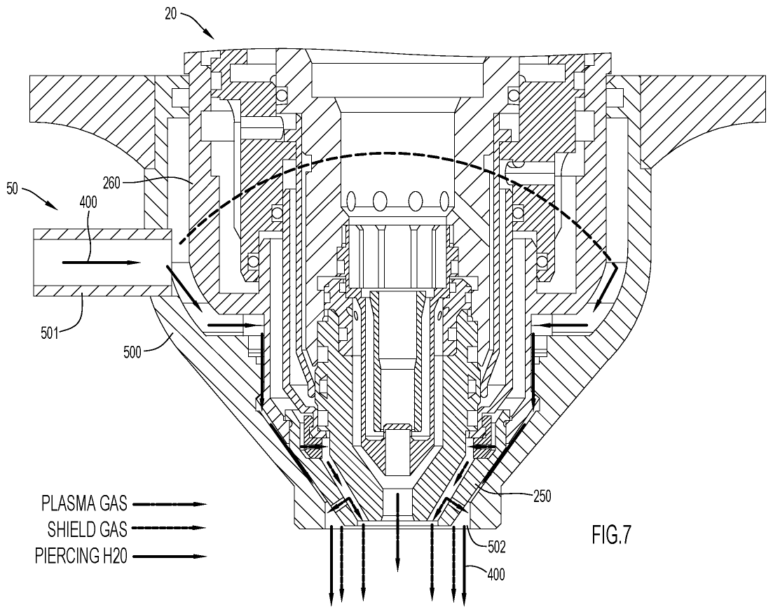

Now referring to FIGS. 6 and 7, a cooling arrangement of a shield club assembly 50 according to a second embodiment is depicted. The shield club assembly 50 is substantially similar to shield club assembly 30, and for simplicity and clarity, only differences will between the two embodiments will be described. The shield club assembly 50 includes a shield club 500 and an external cooling fluid feed line 501 for supplying cooling fluid 400 to cool the shield club assembly 50 and the outermost portion(s) of the consumable stack 20 (e.g., the shield 250, the shield cup 260, etc.). The feed line 501 extends radially through the shield club 500 and is fluidly coupled to an internal cavity of the shield club 500. Cooling fluid 400 may flow through the feed line 501 into the shield club 500 and around the shield cup 260 of the consumable stack 20. The cooling fluid 400 absorbs and dissipates heat from the shield club 500 and the outermost component(s) of the consumable stack 20 (e.g., shield cup 260 and shield cap 250). That is, the cooling fluid 400 cools the shield club 500 and/or an outermost portion(s) of the consumable stack 20.

In the depicted embodiment, the cooling fluid 400 is discharged from a distal end opening 502 of the shield club 500. However, in other implementations, the cooling fluid 400 flows through the consumable stack 20 and the torch head, back to a cooling fluid reservoir. In other implementations, the cooling fluid exits the shield club 500 to the cooling fluid reservoir via a return line substantially parallel to and radially offset from feed line 501. In yet other implementations, the cooling fluid may be discharged from the shield club 500 in a combination of exit ports (e.g., via the distal end opening 502, via the consumable stack 20 to the torch head, and/or via an external return line).

With the consumables and/or techniques presented herein, consumables for a cutting torch head 60 will experience less wear during a cutting operation and can withstand higher temperatures from high-amp (i.e., high current) plasma cutting operations as compared to a conventional torch head. That is, when used with the club assembly 30, 50 presented herein, cutting consumables may have longer lifespans. The shield club assembly 30, 50 results in improved heat dissipation during high-amp plasma cutting operations (e.g., a cutting operation having a current of about 800 Amps for piercing and cutting 4-inch stainless steel plates). However, the techniques described herein may be used with any plasma cutting operation. The improved heat dissipation results in less wear and premature failure of consumables in the consumable stack 20. Consequently, more pierces/cuts may be performed with a desired cut quality between stoppages for replacing worn/damaged consumables as compared to conventional cutting torches.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method. While the invention has been illustrated and described in detail and with reference to specific embodiments thereof, it is nevertheless not intended to be limited to the details shown, since it will be apparent that various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

Reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above,” “below,” “upper,” “lower,” “top,” “bottom,” “left,” “right,” “front,” “rear,” “side,” “height,” “length,” “width,” “interior,” “exterior,” “inner,” “outer,” or other similar terms merely describe points of reference and do not limit the present invention to any particular orientation or configuration. When used to describe a range of dimensions and/or other characteristics (e.g., time, pressure, temperature, distance, etc.) of an element, operations, conditions, etc. the phrase “between X and Y” represents a range that includes X and Y.

Further, the term “exemplary” is used herein to describe an example or illustration. Any embodiment described herein as exemplary is not to be construed as a preferred or advantageous embodiment, but rather as one example or illustration of a possible embodiment.

Further, the present disclosure may repeat reference numerals and/or letters in the various examples. This repetition is for the purpose of simplicity and clarity, and does not in itself dictate a relationship between the various embodiments and/or configurations discussed.

When used herein, the term “comprises” and its derivations (such as “comprising”, “including,” “containing,” etc.) should not be understood in an excluding sense, that is, these terms should not be interpreted as excluding the possibility that what is described and defined may include further elements, steps, etc. Meanwhile, when used herein, the term “approximately” and terms of its family (such as “approximate,” etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the similar terms, such as, but not limited to, “about,” “around,” and “substantially.”

As used herein, unless expressly stated to the contrary, use of the phrase “at least one of”, “one or more of”, “and/or”, and variations thereof are open-ended expressions that are both conjunctive and disjunctive in operation for any and all possible combination of the associated listed items. For example, each of the expressions “at least one of X, Y and Z,” “at least one of X, Y or Z,” “one or more of X, Y and Z,” “one or more of X, Y or Z,” and “X, Y and/or Z” can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z. Further as referred to herein, “at least one of” and “one or more of” can be represented using the “(s)” nomenclature (e.g., one or more element(s)).

Additionally, unless expressly stated to the contrary, the terms “first,” “second,” “third,” etc. are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, “first X” and “second X” are intended to designate two “X” elements that are not necessarily limited by any order, rank, importance, temporal sequence, or hierarchy of the two elements.

What is claimed is:

1. A consumable stack for a torch comprising:
an electrode;
a nozzle surrounding a distal end the electrode;
a shield concentric with a distal end of the nozzle;
an outer shield assembly concentric with a distal end of the shield, the outer shield assembly configured to absorb and dissipate heat from an arc process operation; and
a deflector ring disposed at a proximal end of the outer shield assembly, the deflector ring configured to deflect spatter ejected during the arc process operation away from a torch head of the torch.

2. The consumable stack of claim 1, further comprising a shield cup disposed between the outer shield assembly and the shield, the shield cup configured to mount the shield to the torch head.

3. The consumable stack of claim 2, wherein a radial gap between the shield cup and the outer shield assembly defines a cooling channel for receiving a flow of cooling fluid.

4. The consumable stack of claim 2, wherein the proximal end of the outer shield assembly engages the shield cup.

5. The consumable stack of claim 2, wherein a distal end of the shield cup engages a proximal end of the shield, and a proximal end of the shield cup engages the torch head.

6. The consumable stack of claim 1, wherein a cross-sectional thickness of the outer shield assembly is configured to absorb and dissipate the heat from the arc process operation.

7. The consumable stack of claim 1, wherein a cross-sectional thickness of a sidewall of the outer shield assembly varies between a distal end and the proximal end of the outer shield assembly.

8. A method comprising:
guiding a flow of cooling fluid to an interior of an electrode of a torch;
guiding the flow cooling fluid from the electrode to a nozzle;
guiding the flow cooling fluid from the nozzle to a shield and/or a shield cup;
guiding the flow cooling fluid from the shield and/or the shield cup to an outer shield assembly; and
guiding the flow of cooling fluid from the outer shield assembly to a torch head of the torch for return to a cooling fluid supply.

9. The method of claim 8, further comprising guiding the flow of cooling fluid between the shield and the outer shield assembly and discharging the flow from the outer shield assembly through an exit orifice at a distal end of the outer shield assembly.

10. The method of claim 8, further comprising cooling the electrode, the nozzle, the shield and/or the shield cup, and the outer shield assembly with the flow of cooling fluid.

11. The method of claim 8, wherein the flow of cooling fluid comprises water.

12. A shield assembly for an arc processing torch, the shield assembly comprising:
a shield club with a sidewall extending from a proximal end to a distal end, the sidewall defining a proximal opening at the proximal end, a distal opening at the distal end, and a cavity for receiving one or more consumables, wherein a radial thickness of the sidewall is based on a desired thermal mass; and
a deflector ring coupled to the proximal end of the sidewall, wherein the deflector ring is configured to deflect spatter from an arc processing operation.

13. The shield assembly of claim 12, wherein the radial thickness of the sidewall varies from the proximal end to the distal end.

14. The shield assembly of claim 13, wherein the radial thickness corresponding to a particular portion of the sidewall is based on a desired localized thermal mass for the particular portion of the sidewall.

15. The shield assembly of claim 14, wherein the desired localized thermal mass corresponds to a desired amount of heat to be absorbed at the particular portion of the sidewall during the arc processing operation.

16. The shield assembly of claim 12, wherein the desired thermal mass is based on a desired amount of heat to be absorbed and dissipated during the arc processing operation.

17. The shield assembly of claim 12, wherein the sidewall is configured to protect the one or more consumables and/or torch head from the spatter and heat from the arc processing operation.

18. The shield assembly of claim 12, further comprising a shield cup and a shield, the shield cup being disposed between the shield club and the shield and being configured to mount the shield to a torch head.

19. The shield assembly of claim 18, wherein a radial gap between the shield cup and the shield club defines a cooling channel for receiving a flow of cooling fluid.

20. The shield assembly of claim 19, wherein a distal end of the shield cup engages a proximal end of the shield, and a proximal end of the shield cup engages the torch head.
